(19) United States
(12) Patent Application Publication
(10) Pub. No.: US 2013/0121536 A1
(43) Pub. Date: May 16, 2013

(54) DEVICE AND METHOD FOR CONTROLLING TRAFFIC LIGHTS

(71) Applicants: SZU-LUN HUANG, Tu-Cheng (TW); CHIH-HUANG WU, Tu-Cheng (TW)

(72) Inventors: SZU-LUN HUANG, Tu-Cheng (TW); CHIH-HUANG WU, Tu-Cheng (TW)

(21) Appl. No.: 13/660,979

(22) Filed: Oct. 25, 2012

(30) Foreign Application Priority Data
Nov. 15, 2011 (TW) 100141512

(51) Int. Cl. G06K 9/00

(52) U.S. Cl. 382/104

(57) ABSTRACT

A traffic light control device for adjusting time duration of illumination of lights of a traffic light, includes several image capturing units to capture images of specific areas around the traffic light, and an image analysis unit to divide each image captured by the image capturing units into a plurality of areas, and to analyze the plurality of areas to determine which of the plurality of areas contain predefined objects. Further provided are a calculating unit to calculate ratio of a number of areas containing predefined objects of each captured image to a total number of the areas of each captured image; and a control module to determine whether to adjust the time duration of illumination of the lights of the traffic light based on the ratio calculated based on the images captured by the image capturing units.

### BACKGROUND

1. Technical Field

The present disclosure relates to a device and a method for controlling lights of a traffic light.

2. Description of Related Art

The traffic light control systems are usually arranged inside a cabinet positioned beside a road. The lights of the traffic light are controlled by a microprocessor in the system. One problem with some traffic light control systems is that the control parameters cannot be automatically adjusted according to traffic patterns.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic block diagram of a traffic light control device in accordance with an exemplary embodiment.

FIG. 2 is a schematic view showing an image divided into several areas with some areas marked.

FIG. 3 is a flow chart of a traffic light method in accordance with an exemplary embodiment.

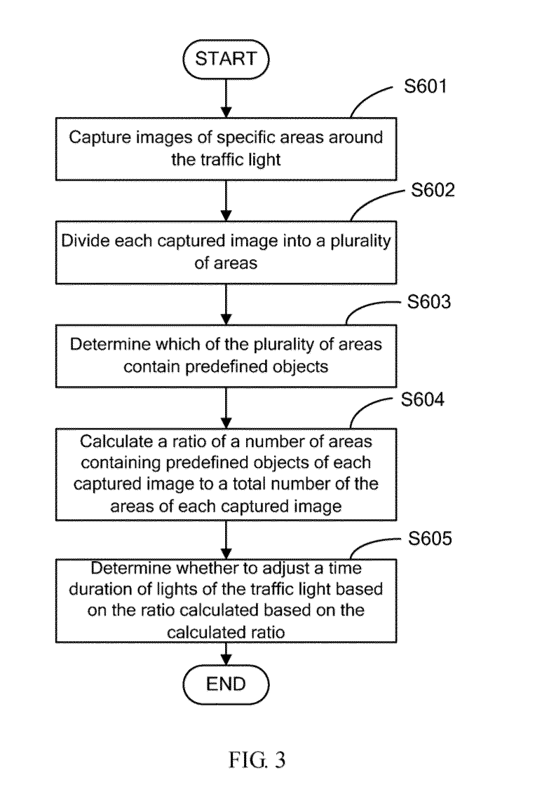

### DETAILED DESCRIPTION

Embodiments of the present disclosure will be described with reference to the accompanying drawings.

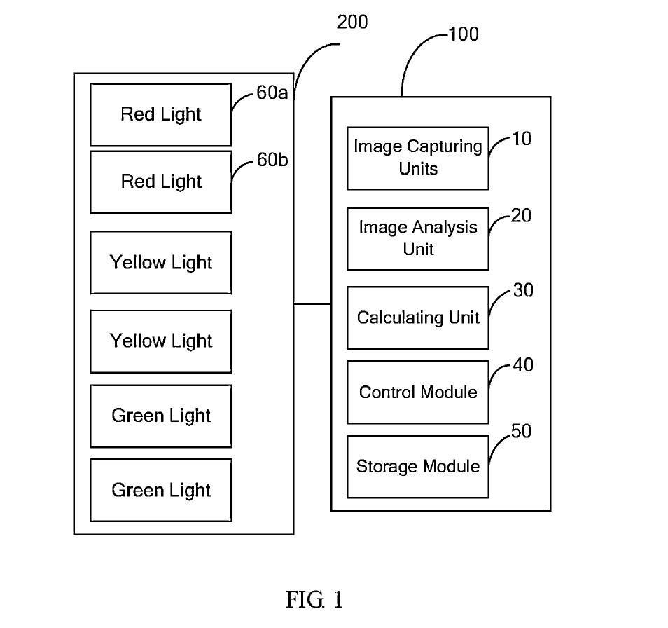

Referring to FIG. 1, a traffic light control device 100 includes a number of image capturing units 10, an image analysis unit 20, a calculating unit 30, and a control unit 40. The traffic light control device 100 is electrically connected to a traffic light 200 and used to control timing of illumination of lights of the traffic light 200, such as red lights 60a and 60b, and the image capturing units 10 are used to capture images of specific areas around the traffic light 200.

The image analysis unit 20 divides each image captured by the image capturing units 10 into a number of areas 70. For example, each image can be equally divided into areas of X rows and Y columns. The image analysis unit 20 analyzes these areas 70 and determines which of these areas 70 contain predefined objects. In the embodiment, when one area 70 is determined to contain predefined objects, one or more following areas 70 sharing boundaries with the one area 70 will be assumed to contain predefined objects. The areas 70 that are determined or assumed to contain predefined objects will be marked. The image analysis unit 20 will analyze the areas 70 in a preset order, and will skip the marked areas 70 assumed to contain predefined objects.

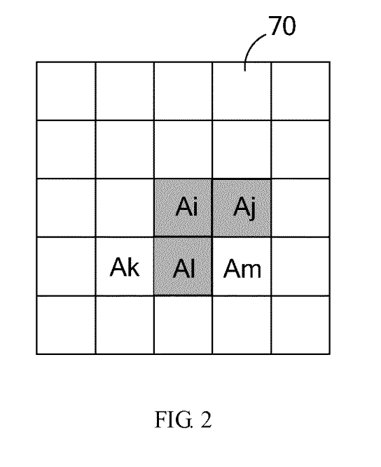

Referring to FIG. 2, for example, the image analysis unit 20 analyzes the areas 70 row by row, and in each row, the areas 70 will be analyzed from left to right. When determining that an area Ai contains predefined objects, two following areas Aj and Al sharing boundaries with the area Ai are assumed to contain predefined objects, and the areas Ai, Aj and Al will be caused to be grayed. The image analysis unit 20 then continues on for the remaining areas 70 in the same manner. In this example, after analyzing the area Ak, the image analysis unit 20 skips the area Al assumed to contain predefined objects and analyzes the area Am.

In the embodiment, the traffic light control device 100 further includes a storage unit 15 that stores a reference image for each of the specific areas around the traffic light 200. The image analysis unit 20 compares each image captured by the image capturing units 10 with the corresponding reference image, and determines that there are no predefined objects if the captured image and the reference image are the same. Otherwise, the image analysis unit 20 determines that there are predefined objects if the captured image and the reference image are different from each other.

The calculating unit 30 calculates a ratio of the number of the marked areas of each captured image to the total number of the areas of the captured image. The control unit 40 determines whether to adjust the parameters (e g , timing and time duration) of illumination of the lights of the traffic light 200 according to the ratios calculated based on the captured images. Specifically, if the ratios calculated based on the captured images are all less than a predetermined value, the control unit 40 will not adjust the parameters of illumination of the lights of the traffic light 200. If one or more ratios calculated based on the captured images are greater than predetermined value, the control unit 40 adjusts the parameters of illumination of the lights of the traffic light 200 corresponding to the one or more ratios. For example, if the traffic light 200 is located at a road intersection and there are many vehicles on one road, the ratio calculated based on the image captured from specific area of the road will exceed the predetermined value, the control unit 40 then decreases the time duration of illumination of the red light for the road with heavy traffic and increases the time duration of illumination of the red lights for the other roads at the intersection.

FIG. 2 is a flow chart of a method for controlling a traffic light 200 in accordance with an exemplary embodiment.

In step S301, the capturing units 10 captures images of specific areas around the traffic light 200. In step S302, the image analysis unit 20 divides each image captured by the image capturing units 10 into a number of areas 70. In step S303, The image analysis unit 20 analyzes these areas 70 and determines which of these areas 70 contain predefined objects. In step S304, the calculating unit 30 calculates a ratio of the number of the marked areas of each captured image to the total number of the areas of the captured image. In step S305, the control unit 40 determines whether to adjust the parameters of illumination of the lights of the traffic light 200 according to the ratios calculated based on the captured images.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A traffic light control device for adjusting time duration of illumination of lights of a traffic light, the traffic light control device comprising:
a plurality of image capturing units configured to capture images of specific areas around the traffic light;
an image analysis unit configured to divide each image captured by the image capturing units into a plurality of areas, and analyze the plurality of areas to determine which of the plurality of areas contain predefined objects;
a calculating unit to calculate ratio of a number of areas containing predefined objects of each captured image to a total number of the areas of each captured image; and
a control module to determine whether to adjust the time duration of the lights of illumination of the traffic light based on the ratio calculated based on the images captured by the image capturing units.

2. The traffic light control device according to claim 1, wherein the image analysis unit analyzes the plurality of areas in a preset order, if one area is determined to contain predefined objects, the image analysis unit determines that one or more following areas sharing boundaries with the one area contain predefined objects.

3. The traffic light control device according to claim 1, further comprising a storage unit, wherein the storage unit a plurality of reference images, the image analysis unit compares each of the images captured by the plurality of image capturing units with the corresponding one of the plurality of reference images to determine which of the plurality of areas contain predefined objects.

4. The traffic light control device according to claim 1, wherein the image analysis unit divides each image captured by the image capturing units into a plurality of equal areas, and analyzes the areas row by row.

5. The traffic light control device according to claim 2, wherein the areas that are determined to contain predefined objects are marked by the image analysis unit.

6. A method for controlling a traffic light, comprising:
capturing images of specific areas around the traffic light;
dividing each captured image into a plurality of areas;
analyzing the plurality of areas and determining which of the plurality of areas contain predefined objects;
calculating a ratio of a number of areas containing predefined objects of each captured image to a total number of the areas of each captured image; and
determining whether to adjust a time duration of illumination of lights of the traffic light based on the ratio calculated based on the calculated ratio.

7. The method according to claim 6, wherein if one area is determined to contain predefined objects, determining that one or more following areas sharing boundaries with the one area contain predefined objects.
